(19) United States
(12) Patent Application Publication
(10) Pub. No.: US 2015/0134657 A1
(43) Pub. Date: May 14, 2015

(54) Data Imparting Apparatus and Method for Providing References to Data Records in a User Database

(71) Applicants: Karsten Ehms, Munchen (DE); Manfred Langen, Munchen (DE); Bernd Lindner, Kirchheim (DE)

(72) Inventors: Karsten Ehms, Munchen (DE); Manfred Langen, Munchen (DE); Bernd Lindner, Kirchheim (DE)

(21) Appl. No.: 14/537,635

(22) Filed: Nov. 10, 2014

(30) Foreign Application Priority Data
Nov. 11, 2013 (DE) 102013222891.0

(51) Int. Cl. G06F 17/30

(52) U.S. Cl. CPC G06F 17/30595
USPC 707/736

(57) ABSTRACT

Automatic identification and prioritization of user profiles in network-based application systems are provided. When creating network-based content, references to a plurality of user profiles within the entire network system may be automatically identified by specifying a user identifier, and references to one or more of these user profiles may then be determined according to user specifications or specified guidelines. The content of a network-based application may then always be supplemented with references to user profiles according to the user profiles identified in this manner.

This application claims the benefit of DE 10 2013 222 891.0, filed on Nov. 11, 2013, which is hereby incorporated by reference in its entirety.

### BACKGROUND

The present embodiments relate to a data imparting apparatus and to a method for providing references to data records.

Network-based application systems may be used by a group of registered persons. In addition, such registered persons may also be users of further network-based systems. During registration, the users may store specific, personal data in each of these network-based systems. If necessary, these stored data may be supplemented or modified at a later time. Examples of such network-based application systems are the personalized cloud services of Google, Facebook, etc., for example. However, specially adapted network-based applications in an internal company intranet, for example, are also known.

In all of these network-based application systems, a user stores in each case a separate user profile that is independent of the other application systems during each registration with an application system. In this case, the data in the individual user profiles may differ to a greater or lesser extent from one another.

If these user profiles are available, further network-based services may access these profile data and/or refer to the profile data. For example, web-based systems may make it possible to provide cross-system hypertext references (e.g., links) to these user profiles.

If an author would like to refer to profile information relating to a user when creating content for a network-based application (e.g., when creating a webpage), the profile information relating to the user, to which reference is intended to be made, has previously been selected in an arbitrary manner as far as possible. The author may not know all available profiles of the user, to which a reference might be possible, when creating the new content. Therefore, the selection is restricted to the user profiles known to the author. The user, to whose profile data reference is intended to be made, may have no influence on which data in his user profiles an author will refer to.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a data imparting apparatus and a method for providing references to data records in a user database are provided. As another example, references are provided to user data records in an efficient and automatable manner. Also, references are provided to user data records, where the provision may be controlled by a user.

According to a first aspect, a method for providing references to data records in a user database is provided. The method includes receiving a user identifier from a requesting device, and receiving a plurality of references to data records stored in the user database. The received references to data records correspond to the received user identifier. The method also includes determining a sequence for the received references to data records in the user database using a predetermined set of rules, selecting at least one reference to user data records based on the determined sequence of the received references, and transmitting the selected at least one reference to the requesting device.

In a further aspect, a data imparting apparatus for providing references to data records in a user database is provided. The data imparting apparatus includes a first interface configured to receive a user identifier from a requesting device, and a second interface configured to receive references to a plurality of data records stored in the user database from the user database. The received references correspond to the user identifier that has been received by the first interface. The data imparting apparatus also includes a processing device configured to determine a sequence for the received references to data records in the user database using a predetermined set of rules and to select at least one reference based on the determined sequence of the received references. The first interface is also configured to transmit the selected at least one reference to the requesting device.

One or more of the present embodiments are based on the idea of providing a central profile imparting apparatus that makes it possible for an author of network-based contents to find existing user profiles for a predefined user and therefore to refer to one or more of these profiles for a user. In addition, such a profile imparting apparatus makes it possible for a user to specify preferences for using his possibly numerous profiles, with the result that the contents preferred by the user may be referred to when creating network-based contents. Providing such a profile imparting apparatus therefore makes it possible for an author for network-based content to embed a reference to profile data relating to users in the content to be created in a very fast and efficient manner. In this case, the profile imparting apparatus automatically identifies and assesses the available profile data and automatically provides a respective matching reference to the data records for suitable profile data relating to a user.

In addition, the automatic comparison of all profile data in the corresponding databases also makes it possible to provide that correct and intact references to user profiles are always provided. A risk of incorrect references or references that no longer function correctly (e.g., dead links or the like) may therefore be excluded to the greatest possible extent. The reliability of the network-based content created by an author therefore also increases.

In addition, the automatic sorting of all references to user data makes it possible to always identify an appropriate user profile for each application and to provide a corresponding reference to the optimum user profile. This also makes it possible to improve the quality of the network-based content with references to user data.

In one embodiment, the method for providing references to data records in a user database also includes receiving an item of prioritization information from a user and storing the received prioritization information in a memory. The act of determining the sequence for the received references determines the sequence using the stored prioritization information.

The use of such an item of prioritization information, which may be individually specified by a user, therefore makes it possible for the user to influence the selection of the user profiles to which reference is made. The user profile preferred by a user may therefore be used.

According to another embodiment, the method includes receiving an application identifier from the requesting device. The determining of the sequence for the received references determines the sequence using the received application identifier.

In this case, the application identifier characterizes, for example, a particular class or specifies the content that is intended to refer to data records (e.g., profile data). The specification of an application identifier makes it possible to further optimize the selection of the provided references when imparting the references to the user profiles. Therefore, depending on the application of the network-based content to be created, for example, references to different profile data may be selected and provided. For example, private applications and professional applications may therefore be distinguished between. In the case of professional applications, for example, suitable profile data relating to career networks may therefore be preferred, whereas private applications refer to user profile data in other databases.

In one embodiment, the method also includes assigning an application identification to each received reference to a data record. The act of determining a sequence for the received references determines the sequence using the received application identifier and the received application identification.

This application identification makes it possible to predefine a prioritization for a particular application or a particular class of applications for each data record (e.g., for each user profile in a database). This makes it possible for a user to deliberately influence the selection for the references to his profile data, depending on the application, when providing his profile data. The selection of references to profile data may therefore be precisely controlled. The selection of the respective user may therefore be controlled when manually assigning the application identification. In addition, the act for assigning an application identification to the respective references to the data records may be carried out in an automated manner. For example, this assignment may be carried out based on predetermined rules or criteria. This makes it possible to further automate and optimize the selection of the references to the profile data.

According to another embodiment, the method also includes providing a content file, identifying a user identifier in the content file, and replacing the user identifier with the transmitted at least one reference to a data record stored in the user database.

In this case, the content file may define contents that may be used to provide network-based information. For example, such a content file may be a static or dynamic webpage (e.g., in the form of an HTML page, an XML structure or the like). This makes it possible to automatically supplement the network-based content of a content file with references to user profiles without an author or user manually having to intervene.

According to one embodiment, the references to data records in the user database are provided in the form of Internet addresses.

Internet addresses (e.g., in the form of a URL) are very well suited for providing access to further data sources (e.g., web servers or the like; in network-based applications).

According to another embodiment, the second interface of the data imparting apparatus is also configured to receive an item of prioritization information for each received reference from the user database. The processing apparatus determines the sequence of the received references using the received prioritization information.

This makes it possible to select the references to the data records in the user database based on information stored together with the profile data in a database.

In an alternative embodiment, the data imparting apparatus also includes an input apparatus configured to receive an item of prioritization information for a received reference from a user, and a memory configured to store the prioritization information. The processing apparatus determines the sequence of the received references using the stored prioritization information.

This makes it possible for a user to influence the sequence of the selected references to his user data and to influence the automatic selection process.

In another embodiment, the second interface of the data imparting apparatus is configured to receive references to user data from a plurality of user databases.

The user data may be provided by different, possibly also heterogeneous data sources. In this case, the central data imparting apparatus makes it possible, in a simple and efficient manner, to centrally manage all of these heterogeneous data sources and to enable an efficient selection of references to the profile data.

In one embodiment, one or more of the present embodiments also include a system for providing user-specific data. The system includes a data imparting apparatus and a content generator including a search apparatus configured to identify a user identifier in a content file. The system also includes a requesting device configured to transmit the identified user identifier to the data imparting apparatus and to receive a reference to a data record in a database. The system includes a substitution apparatus configured to replace the identified user identifier with the received reference.

### BRIEF DESCRIPTION OF THE DRAWINGS

FIG. 1 shows a schematic illustration of one embodiment of a system for providing user-specific data that includes a data imparting;

FIG. 2 shows a schematic illustration of a screen page with network-based content as generated according to an exemplary embodiment; and

FIG. 3 shows a schematic illustration of a flowchart for one embodiment of a method.

### DETAILED DESCRIPTION

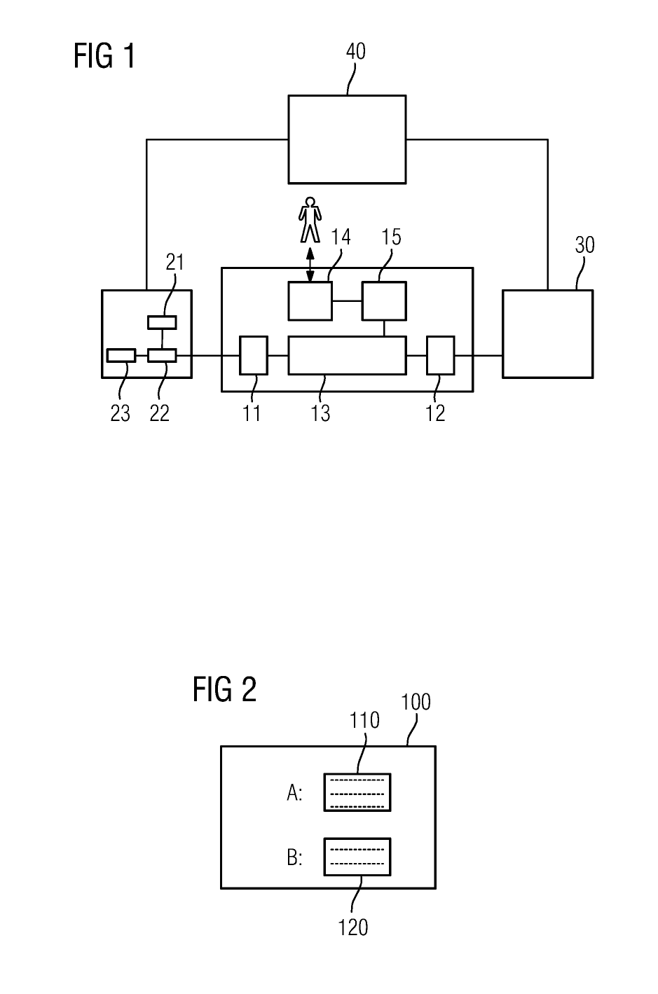

FIG. 1 shows a schematic illustration of one embodiment of a system for providing user-specific data. A content file is created in a content generator 20. The content file may be, for example, a static or dynamic webpage. Such a content file may be created and stored, for example, as an HTML file or the like. Other data structures for specifying network-based contents may also be provided. The content file may also have XML structures, for example. Even simple text files may be provided.

The content file is intended to refer to at least one user profile. For this purpose, a search apparatus 21 in the content generator 20 searches the content file in order to possibly identify data that refers to a user in the content file. For example, the content file may be searched for the name of a user, or a search for a special user identifier or the like is carried out. In addition, an author may specify, as early as when creating such a content file, the location in the content file at which reference is intended to be made to a particular user. Alternatively, the user identifier may also be determined manually by the author of the content file during or after the creation of the content file.

After a user identifier has been identified or determined, the requesting device 22 sends a request containing the corresponding user identifier to the data imparting apparatus 10. A first interface 11 in the data imparting apparatus 10 receives this request. The received user identifier is then forwarded to the processing device 13 that determines data sources that provide user profiles for the received user identifier. In this case, these user profiles may be provided in one or more databases 30. In principle, however, other data sources may also be provided. In the text below, the term “databases” is therefore intended to be understood as being any type of data source that makes it possible to provide data relating to a user profile within a network-based application system. In addition to databases, such data sources may also be web servers or the like, for example.

In order to determine the databases that provide profile data for the received user identifier, a request may be sent to the database 30 via a second interface 12, for example. In response to this request, the second interface 12 then receives a corresponding response from the database 30. This response may contain, for example, a reference that specifies how the database 30 is to be addressed in order to obtain the user profile corresponding to the user identifier from this database 30. In addition, this response may also contain an item of prioritization information that indicates how relevant the user profile provided by the database 30 is. For this purpose, a user may specify a corresponding item of prioritization information, for example, as early as when creating his user profile on the database 30. A user may also subsequently supplement and modify this prioritization information in connection with the user profile.

The data imparting apparatus 10 may also store details relating to the prioritization of particular user profiles. For this purpose, the data imparting apparatus 10 may have an input apparatus 14 that may be used by a user to prioritize one or more particular user profiles. A user may therefore state whether the intention is always to refer to a particular user profile in the database 30 or in what sequence a plurality of specified user profiles in the database 30 are intended to be selected. This prioritization information specified by the user using the input apparatus 14 may be stored in a suitable memory 15 of the data imparting apparatus 10. The prioritization information stored in this manner and/or the prioritization information received by the second interface 12 of the data imparting apparatus 10 may be used in this case as a basis for selecting a user profile corresponding to the received user identifier.

After the data imparting apparatus 10 has determined one or more references to user profiles corresponding to a received user identifier, these references are sorted in the processing apparatus 13 of the data imparting apparatus 10. For this purpose, the processing device 13 determines a sequence for the preference of the received references to the data records. The sequence may be determined based on a predetermined set of rules. For example, the received references to the data records may be determined based on the corresponding received or stored prioritization information. This makes it possible to sort the sequence of the references based on criteria predefined by the user, with the result that the sequence of the sorted references reflects the user's preferences. In addition, further criteria for sorting the references to the data records may be provided.

For example, the individual user profiles may also be classified. For example, private or commercial user profiles may be distinguished between. Further classifications and subdivisions of the user profiles may also be provided. For example, user profiles that come from career networks may be assigned to one class. Other classes may include, for example, user profiles from applications for sports or fitness activities or user profiles that belong to predetermined activities (e.g., travel, photography, motor sport etc.). This enables automatic classification based on predetermined rules. In addition, a user may also carry out a manual classification for each profile when creating or modifying his profile data.

If the data imparting apparatus 10 also receives, together with the user identifier, a specification of a particular application, the sequence of the available user profiles may also be sorted in this case based on a comparison with the classifications corresponding to the user profiles.

If, for example, the intention is to create content that deals with leisure activities, the processing device 13 of the data imparting apparatus 10 may prioritize user profiles with a corresponding classification.

After the processing device 13 of the data imparting apparatus 10 has sorted the available references to user profiles according to the specifications, one or more of these references is selected. These selected references to user profiles are then sent to the requesting device 22 of the content generator 20 via the first interface 11 of the data imparting apparatus 10. The received reference(s) to the corresponding user profiles is/are then inserted into the content file. A content file, which always contains current references to user profiles that correspond to the preferences of the user to whom reference is intended to be made, and which may also be adapted with respect to the classification of the content, is therefore created in the content generator 20. In this case, the references to the user profile data are selected and embedded automatically.

If a terminal 40 then calls such a content file in a network-based application, the content file is transmitted from the content generator 20 to the terminal 40 and is output in the terminal 40. In this case, the content file contains the added references to the respective user profiles. The corresponding user profile in the database 30 may therefore be directly accessed by selecting such a reference, for example, by correspondingly clicking on a webpage.

As an alternative to inserting a single reference in the content file, a plurality of references to different user profiles may be respectively inserted. For example, a predetermined number of user profiles may be displayed for this purpose in the sequence determined by the processing device 13 of the data imparting apparatus 10. For example, a selection or a menu containing a plurality of references to different user profiles may, for example also be displayed. The references may be displayable in the sequence determined by the processing device 13 of the data imparting apparatus 10.

In this case, the references to the user profiles may be inserted in the content file once when creating the content file. Alternatively, the references may also be regularly updated in the content file. For example, the updating may be carried out at predetermined intervals of time. Alternatively, the references may be respectively updated when calling the corresponding content file. This makes it possible to always keep the references contained in the content file up-to-date and to also possibly take into account changing specifications by the user or as a result of a change in the classification of the profile data.

FIG. 2 shows a schematic illustration of an exemplary page 100 containing references to profile data relating to users. In this case, the upper half relates to a user A. For further information relating to this user A, three references 110 to corresponding user profiles are indicated in this case (e.g., on the right-hand side).

The lower half relates to a further user B. In this case too, a plurality of references 120 to corresponding user profiles are illustrated in the right-hand half.

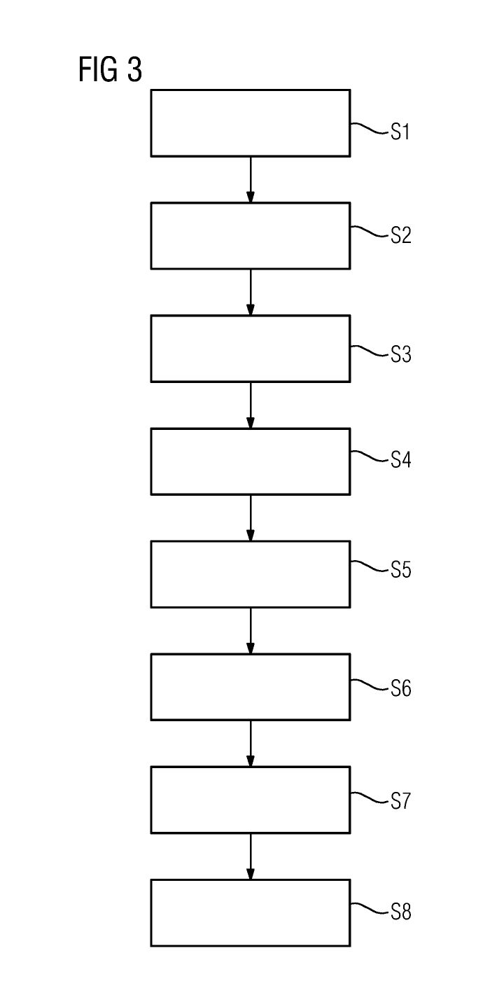

FIG. 3 shows a schematic illustration of a flowchart for one embodiment of a method for providing references to data records in a user database. Optionally, a content file is provided in a content generator in act S1, and a user identifier is identified in the content file in act S2. The identified user identifier is transmitted from the content generator to a data imparting apparatus 10. The data imparting apparatus 10 receives the transmitted user identifier in act S3. In act S4, a plurality of references to data records stored in a user database 30 are received in the data imparting apparatus 10. The received references to data records correspond to the received user identifier. In act S5, a sequence for the received references to data records in the user database is determined using a predetermined set of rules. This set of rules may include, for example, the evaluation of additionally received prioritization information. Additionally or alternatively, an application identifier may also be received in the data imparting apparatus 10. This application identifier may be concomitantly included in the sorting of the references to data records received in act S5 based on the predetermined set of rules. An application identification may also be received together with the received references to data records. In this case, this application identification may be evaluated together with the application identifier and may be included in the determination of the sequence for the received data records.

After the sequence for the received references to data records has been determined, at least one reference to data records is selected based on this determined sequence in act S6, and this at least one selected reference is transmitted to the content generator in act S7. The content generator then adds the references to data records in the user database 30 to the content file at the identified locations. One or more transmitted references to data records may be inserted in the content file at the required locations in act S8.

Numerous applications may be provided based on such automated imparting of references to user profiles. For example, a moderator of a community may call an application for an event. For this purpose, the participants are requested to register on a predetermined page (e.g., on a webpage). In this case, the data imparting apparatus 10 speeds up the robust linking of the user profiles. This applies both to entries that are made by the moderator and to the registration by the participants.

Another application example makes it possible to automatically link user profiles in an electronic employee directory. If, in addition to the predominantly static organizational information, the intention is to link further profile pages for internal or external social media or the like in such an electronic employee directory, the employee may control the indication of such references to further user profiles in this case by specifying his prioritization in the individual user profiles. The integrated application system that provides the employee directory only calls a simple, standardized network address in this case. As a result of this standardized network address being called, the data imparting apparatus 10 collects all available user profiles and evaluates the user profiles according to the previously described specifications and rules. In response to this, a profile preferred by the respective employee is returned.

Another application example makes it possible to use different preferences for private profiles and commercially used profiles. Stating the respective classification when calling the data imparting apparatus 10 makes it possible in this case to provide references to different profiles depending on the application. For example, a reference to a profile in Facebook or Google may be returned for a simple request as a private user profile, whereas a commercial request delivers a profile from a career network.

In another exemplary embodiment, user profiles may also be mutually linked in a plurality of existing systems. In this case, when the profile page of a user is called, the data imparting apparatus 10 may determine further profiles, and one or more references to such further user profiles may be respectively concomitantly output when outputting the user profile.

In yet another exemplary embodiment, author meta data may also be automatically linked. The authors may be automatically indicated as meta data in social media for user-generated contents (e.g., in blog entries, in Wikipedia pages, when commenting, etc.). In contrast to conventional linking to static user profiles, the use of a data imparting apparatus 10 according to one or more of the present embodiments makes it possible to automatically link to one or more user profiles in other systems. In this case, when selecting the references to the user profiles, either the preference of the currently active reader, the preference of the author who created the content, or a predefined rule may influence the selection of the respective user profile or the sequence in which the user profiles are output.

In summary, one or more of the present embodiments relate to automatic identification and prioritization of user profiles in network-based application systems. When creating network-based content, references to a plurality of user profiles within the entire network system may be automatically identified by specifying a user identifier, and references to one or more of these user profiles may then be determined according to user specifications or specified guidelines. The content of a network-based application may then always be supplemented with references to user profiles according to the user profiles identified in this manner.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for providing references to data records in a user database, the method comprising:
receiving, at a data imparting apparatus, a user identifier from a requesting device;
receiving a plurality of references to data records stored in the user database, the plurality of received references to data records corresponding to the received user identifier;
determining, by the data imparting apparatus, a sequence for the plurality of received references to data records in the user database using a predetermined set of rules;
selecting, by the data imparting apparatus, at least one reference to user data records based on the determined sequence for the plurality of received references; and
transmitting, by the data imparting apparatus, the selected at least one reference to the requesting device.

2. The method of claim 1, further comprising:
receiving an item of prioritization information from a user; and
storing the received item of prioritization information in a memory,
wherein determining the sequence for the plurality of received references comprises determining the sequence for the plurality of received references using the stored item of prioritization information.

3. The method of claim 1, further comprising receiving an application identifier from the requesting device,
wherein determining the sequence for the plurality of received references comprises determining the sequence for the plurality of received references using the received application identifier.

4. The method of claim 3, further comprising assigning an application identification to each received reference of the plurality of received references to a data record,
wherein determining the sequence for the plurality of received references comprises determining the sequence for the plurality of received references using the received application identifier and the received application identification.

5. The method of claim 1, further comprising:
providing a content file;
identifying a user identifier in the content file; and
replacing the user identifier with the transmitted at least one reference to a data record stored in the user database.

6. The method of claim 5, wherein the plurality of references to data records stored in the user database are provided in the form of Internet addresses.

7. The method of claim 2, further comprising receiving an application identifier from the requesting device,
wherein determining the sequence for the plurality of received references comprises determining the sequence for the plurality of received references using the received application identifier.

8. The method of claim 7, further comprising assigning an application identification to each received reference of the plurality of received references to a data record,
wherein determining the sequence for the plurality of received references comprises determining the sequence for the plurality of received references using the received application identifier and the received application identification.

9. The method of claim 8, further comprising:
providing a content file;
identifying a user identifier in the content file; and
replacing the user identifier with the transmitted at least one reference to a data record stored in the user database.

10. The method of claim 9, wherein the plurality of references to data records stored in the user database are provided in the form of Internet addresses.

11. A data imparting apparatus for providing references to data records in a user database, the data imparting apparatus comprising:
a first interface configured to receive a user identifier from a requesting device;
a second interface configured to receive references to a plurality of data records stored in the user database from the user database, the received references corresponding to the user identifier that has been received by the first interface; and
a processing device configured to determine a sequence for the received references to the plurality of data records in the user database using a predetermined set of rules and to select at least one reference based on the determined sequence of the received references,
wherein the first interface is configured to transmit the selected at least one reference to the requesting device.

12. The data imparting apparatus of claim 11, wherein the second interface is also configured to receive an item of prioritization information for each received reference from the user database, and
wherein the processing apparatus is configured to determine the sequence of the received references using the received item of prioritization information.

13. The data imparting apparatus of claim 11, further comprising:
an input apparatus configured to receive an item of prioritization information for a received reference from a user; and
a memory configured to store the prioritization information,
wherein the processing apparatus is configured to determine the sequence of the received references using the stored prioritization information.

14. The data imparting apparatus of claim 11, wherein the second interface is configured to receive references to user data from a plurality of user databases.

15. A system for providing user-specific data, the system comprising:
a data imparting apparatus for providing references to data records in a user database, the data imparting apparatus comprising:
a first interface configured to receive a user identifier from a requesting device;
a second interface configured to receive references to a plurality of data records stored in the user database from the user database, the received references corresponding to the user identifier that has been received by the first interface; and
a processing device configured to determine a sequence for the received references to the plurality of data records in the user database using a predetermined set of rules and to select at least one reference based on the determined sequence of the received references, wherein the first interface is configured to transmit the selected at least one reference to the requesting device; and
a content generator comprising:
a search apparatus configured to identify the user identifier in a content file;
the requesting device configured to transmit the identified user identifier to the data imparting apparatus and to receive a reference to a data record in the user database; and
a substitution apparatus configured to replace the identified user identifier with the received reference.

16. The system of claim 15, wherein the second interface is also configured to receive an item of prioritization information for each received reference from the user database, and
wherein the processing apparatus is configured to determine the sequence of the received references using the received item of prioritization information.

17. The system of claim 15, wherein the data imparting apparatus further comprises:
an input apparatus configured to receive an item of prioritization information for a received reference from a user; and
a memory configured to store the prioritization information,
wherein the processing apparatus is configured to determine the sequence of the received references using the stored prioritization information.

18. The system of claim 15, wherein the second interface is configured to receive references to user data from a plurality of user databases.
